(19) United States
(12) Patent Application Publication
(10) Pub. No.: US 2025/0118153 A1
(43) Pub. Date: Apr. 10, 2025

(54) LIVE GAMEPLAY WITH DUAL ROULETTE AND DEALER ASSISTANCE

(71) Applicant: Interblock d.o.o., Menges (SI)

(72) Inventors: John Joseph Connelly, Las Vegas, NV (US); Tomaz Fink, Kamnik (SI); Jeffrey Kowalchuk, Las Vegas, NV (US)

(21) Appl. No.: 18/896,362

(22) Filed: Sep. 25, 2024

Related U.S. Application Data
(60) Provisional application No. 63/587,949, filed on Oct. 4, 2023.

(51) Int. Cl. G07F 17/32

(52) U.S. Cl. CPC G07F 17/3225; G07F 17/322; G07F 17/3288

(57) ABSTRACT

The present disclosure relates to systems and methods for live roulette gaming systems, methods, and computing devices. Embodiments include a roulette gaming table having a first roulette wheel and a second roulette wheel, and at least one computing device to manage gameplay operations at the roulette gaming table. In an example, the computing device may accept, during a first betting window, a first bet from an interactive gaming interface, and begin the first gaming event by initiating a wheel spin of the first roulette wheel. During the wheel spin of the first roulette wheel, a second betting window may be opened for a second gaming event associated with the second roulette wheel. A second bet from the interactive gaming interface may be accepted during the second betting window. The second betting window closes when the wheel spin of the first roulette wheel ends, and after a result of the first gaming event is confirmed at the dealer console, the wheel spin of the second roulette wheel is initiated to begin the second gaming event.

### CROSS REFERENCE TO RELATED APPLICATIONS

This application claims benefit under 35 U.S.C. § 119(e) of Provisional U.S. Patent Application No. 63/587,949, filed Oct. 4, 2023, the contents of which is incorporated herein by reference in its entirety.

### TECHNICAL FIELD

The present disclosure relates generally, but not exclusively, to the field of gaming, particularly electronic table games.

### BACKGROUND INFORMATION

Casinos offer a variety of games to attract players. Such games may include live table games (e.g., roulette, craps, blackjack, etc.), virtual games, physical machines (e.g., slot-like machines and electronic table games), individual player machines, stadium-style group stations, and various gameplay combinations.

Traditional roulette tables require a highly skilled dealer to manage gaming events. A dealer must supervise and manage bets from one or more players, operate the roulette wheel, determine payouts based on the outcome, and address any disputes or technical issues that arise. As a result, the player to dealer ratio is typically 5:1 or 6:1 for roulette games. The player to dealer ratio can be a limiting factor for roulette tables and gaming locations that have a high demand and multiple players waiting to play. A live dealer also comes with the potential for human error and payout mistakes, such as where a losing bet is accidentally paid out or more is paid on a winning bet than should have been paid. Casinos and gaming locations operating roulette tables and live table games must therefore innovate to attract and retain players, maintain profitability, and improve player experience.

### SUMMARY

An embodiment is directed to live roulette gaming systems, methods, and computer programs. Embodiments include a roulette gaming table including a first roulette wheel and a second roulette wheel, and at least one computing device including a processor and a memory having instructions, which when executed by the processor, cause the computing device to perform various operations. Such operations include accepting, during a first betting window, a bet from an interactive gaming interface. The bet may be for a first gaming event to be played on a first roulette wheel at the dual roulette table. Operations further include, beginning, via a dealer console at the roulette gaming tablet, the first gaming event by initiating a wheel spin of the first roulette wheel. During the wheel spin of the first roulette wheel, the computing device may open a second betting window for a second gaming event associated with the second roulette wheel at the dual roulette table, accept, during the second betting window, a bet from the interactive gaming interface, close the second betting window when the wheel spin of the first roulette wheel ends, after a result of the first gaming event is confirmed at the dealer console, initiate a wheel spin of the second roulette wheel to begin the second gaming event.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A is a perspective view of a live roulette gaming table with two roulette wheels, in accordance with an embodiment.

FIG. 1B is a perspective view of another example of a live roulette gaming table with two roulette wheels, in accordance with an embodiment.

FIG. 2 is perspective view of a live roulette gaming table with one roulette wheel, in accordance with an embodiment.

FIG. 3A is a dealer-side view of features of the live roulette gaming table of FIG. 1A, in accordance with an embodiment.

FIG. 3B is a dealer-side view of features of the live roulette gaming table of FIG. 1B, in accordance with an embodiment.

FIG. 4 is a view of a portion of the interior area of the live roulette gaming table, in accordance with an embodiment.

FIG. 5 is an example player interface, in accordance with an embodiment.

FIG. 6 is another example player interface, in accordance with an embodiment.

FIG. 7A is an example of a graphical user interface for a dealer console, in accordance with an embodiment.

FIG. 7B is another example of a graphical user interface for a dealer console, in accordance with an embodiment.

FIG. 8 is an example arrangement of a live roulette gaming table and player stations, in accordance with an embodiment.

FIG. 9 is an example arena arrangement of a live roulette gaming table and player stations, in accordance with an embodiment.

FIG. 10 is a flowchart for an example gameplay operation of a live roulette gaming table and player stations, in accordance with an embodiment.

FIG. 11 is an illustration of an exemplary block diagram representing a general-purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are methods, systems, and non-transitory computer readable storage media that provide a live electronic table game (ETG) for roulette. A roulette table may include a first and second roulette wheel on which alternating games of roulette may be played. When a first game is initiated on the first roulette wheel, a betting window for the second roulette wheel may start. The second game on the second roulette will start after the first game ends, and a new betting window may begin for a next game on the first roulette wheel.

The roulette gaming table and its gameplay interfaces enable dealer-assisted gameplay to enable a plurality of players to play locally or remotely. Players may play on a player station having a display and an interactive interface to place bets. Other remote gaming options, such as playing on a remote or mobile computing device, may be available as well. The compact shape and footprint of the roulette gaming table enable space-saving, efficient placement in a gaming location, such as a casino floor, a pit, a stadium, or a gaming arena. Embodiments may therefore maximize space utilization without compromising the gameplay experience.

Player stations may be positioned around the roulette gaming table in a position to see the roulette gaming table and one or more gaming events occurring on the roulette wheels. A live video feed of the roulette wheels and spins may be provided on the player display to allow a better view of the gaming events, and to see that the gaming events and results on the interactive interface correspond to the live, physical gaming event at the roulette gaming table. In examples the player interface includes a Picture-in-Picture (PIP) live feed of each roulette wheel.

The roulette gaming table further includes an interactive dealer console, which assists a dealer with managing aspects of gaming events, including betting windows, wheel spins, results determinations, and multiple, alternating gaming events between the dual roulette wheels. For example, players may bet on a first roulette wheel while the other roulette is spinning. As a result, significantly more roulette gaming events can be played in a given time, with a significantly higher dealer-to-player ratio than traditional roulette games. In some embodiments, twice the number of games can be played in a same amount of time as a on a single roulette wheel, and the dealer-to-player ratio may be 5:1, 10:1, 50:1, 100:1, 200:1, 250:1, or higher. Dealers may also control a wheel spin direction for one or both roulette wheels.

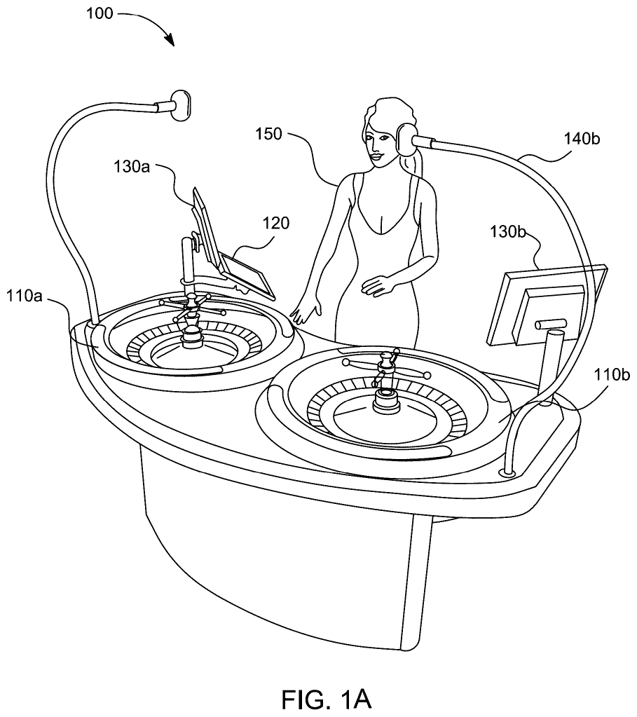

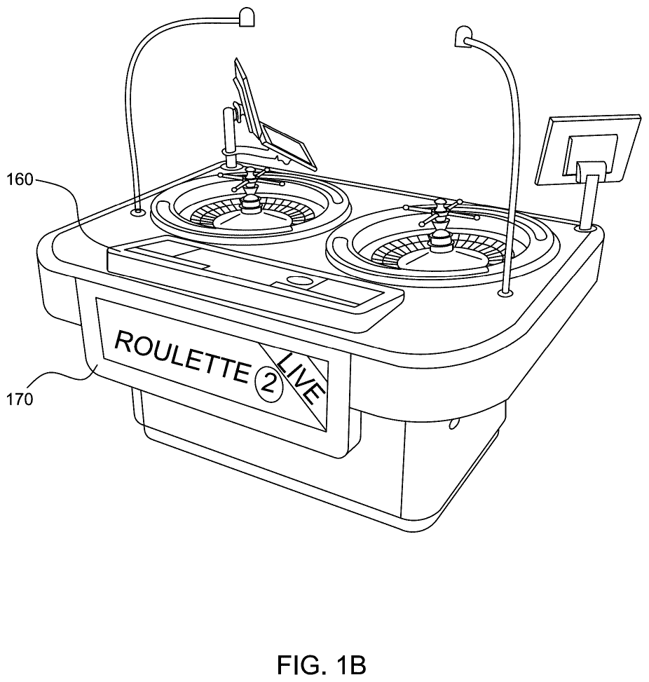

FIGS. 1A and 1B illustrate example roulette gaming tables. FIG. 1A illustrates a first example including a curved roulette gaming table. FIG. 1B illustrates an example roulette gaming table with a larger footprint, and usable, for example, in a stadium or arena arrangement. As seen in FIG. 1A, the roulette gaming table 100 includes a first roulette wheel 110a and a second roulette wheel 110b, which may be provided on a top portion of a gaming cabinet. In some examples, the roulette wheels are built into the top portion of the gaming cabinet. A dealer console 120 enables a dealer 150 to manage and operate aspects of roulette gaming events at the first roulette wheel and the second roulette wheel. For example, the dealer console may initiate a game on the first roulette wheel, and during the game on the first roulette wheel (e.g., when the firs roulette is spinning), the dealer console opens a betting window for a second game on the second roulette wheel. The betting window for the second game closes when the game at the first roulette wheel ends. The end of the first game may occur, for example, when a roulette ball lands in a pocket, when a result is confirmed at the dealer console, or when bets are resolved.

At least one camera (e.g., cameras 140a, 140b) may capture a video feed of the first wheel and the second roulette wheel, to be displayed on at least one display device (e.g., displays 130a, 130b, a display of a player device, etc.). A microphone may be provided to capture audio. The live feed may be a live video feed streamed to the display device to provide a live view of the wheels and gaming events. The live feed may be provided as a PIP on a player display, and as a Picture-in-Display (PID) on one or more displays associated with the dealer console.

In some examples, the roulette gaming table 100 is a semi-circular table. A player side of the roulette gaming table may be longer than a dealer side of the roulette table. The player side may be larger to provide space for viewers, players, and/or player stations. The at least one camera may be positioned above the roulette wheels. A first camera 140a may be positioned above the first roulette wheel 110a, and the second camera 140b may be positioned above the second roulette wheel 110b. The positions of one or both cameras may be adjustable. As seen in FIG. 1A, a camera (e.g., camera 140a) may be attached to an adjustable arm 160 secured to the gaming table 100. The arm may be manipulated to adjust the camera view and may be removably attached to the gaming table 100.

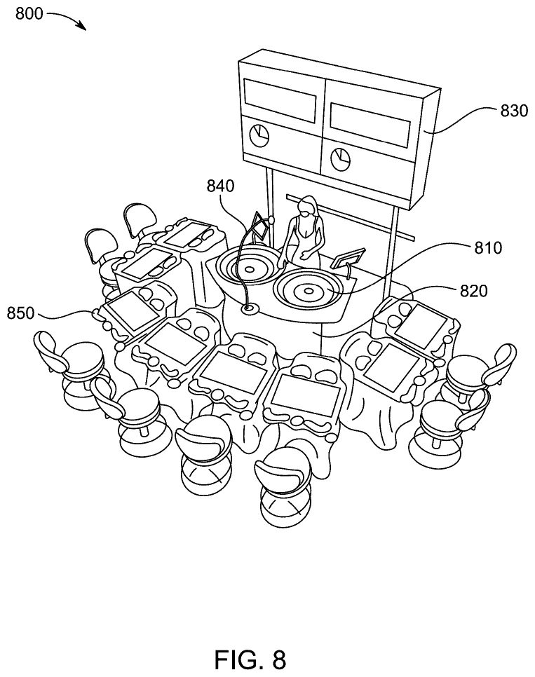

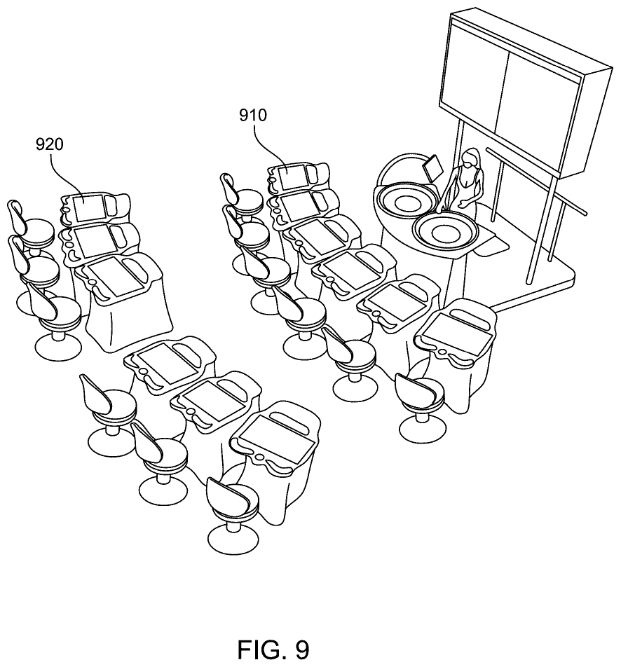

The dealer 150 may stand on one side of the roulette gaming table so as to view the one or more displays (e.g., 130a, 130b), operate the dealer console 120, easily view the roulette wheels, and execute roulette gaming events. In some examples, one or more player stations may be provided on an opposite side of the roulette gaming table (see, e.g., FIGS. 8-9). The roulette gaming table may be used in various gaming locations and environments, such as in casinos, in a stadium or arena environment, or as a standalone unit. In some examples, up to 240 player stations can be connected to the roulette gaming table.

FIG. 1B illustrates similar features as the roulette gaming table of FIG. 1A. The roulette gaming table of FIG. 1B may be usable in a stadium or arena configuration, serving a plurality of player stations. As discussed herein (see, e.g., FIG. 9), the stadium or arena may be located within a gaming location, such as a casino, and be associated with a dedicated section having a perimeter defining the stadium or arena. A plurality of player stations may be arranged within the stadium or arena, facing the roulette gaming table.

The roulette gaming table of FIG. 1B may include an additional control module 160 to view and/or control one or more aspects of the stadium/arena and gameplay. For example, if the stadium/arena contains additional effects, such as lighting, music, video displays, or other entertainment features, the control module 160 may control those effects. The control module 160 may, for example, include an additional display to view information regarding one or more player stations in the arena/stadium. Such information may include a number of active player stations, player information, or gaming information associated with individual player stations. The roulette gaming table may further include signage 170 or other features to identify the game being played in the arena/stadium. The signage 170 may also be helpful to attract players and provide other visual or audio effects, such as lighting, artwork, music, sound effects, etc.

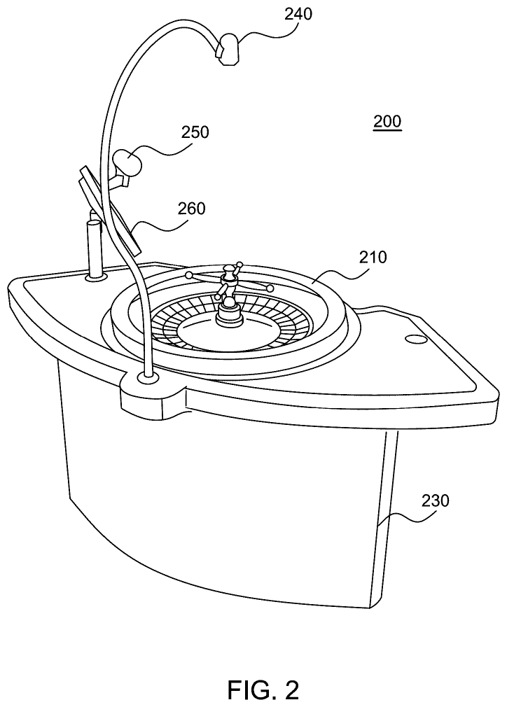

FIG. 2 illustrates another example of a roulette gaming table. The roulette gaming table 200 includes one roulette wheel 210 provided on a top surface of a gaming cabinet 230. Similar to the roulette gaming table 100 of FIGS. 1A-B, the single-roulette wheel table may include a camera 240, a microphone 250, and a display 260. The display may provide at least one of a live video feed of the roulette wheel as captured by the camera 240, and a dealer console interface to enable the dealer to manage and operate aspects of the gaming table 200 and any roulette gaming events.

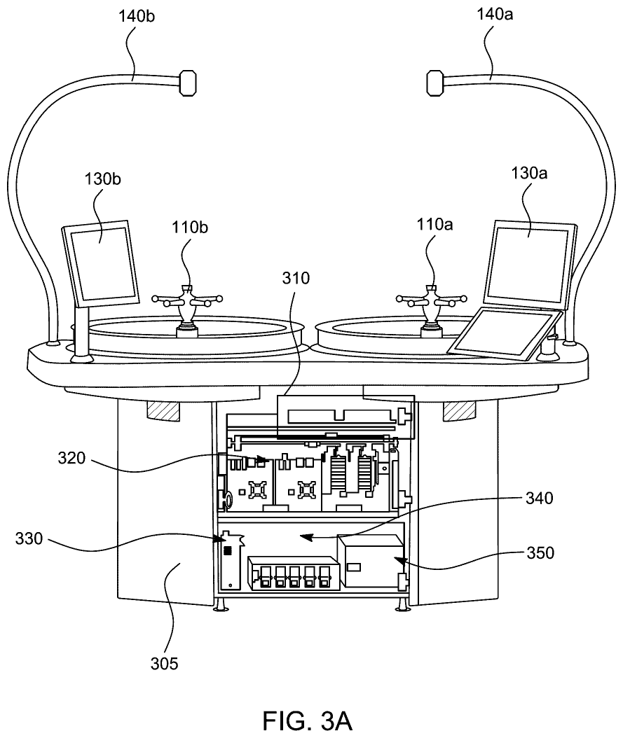

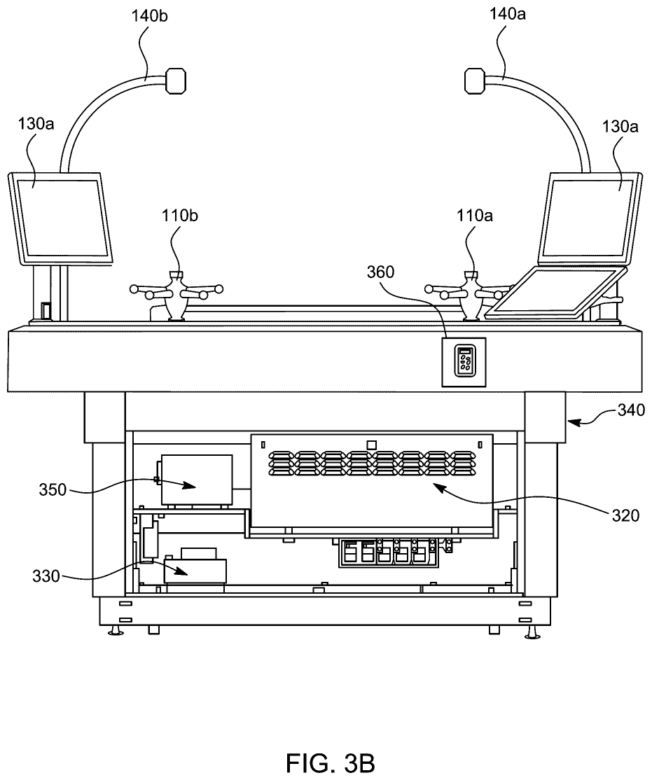

FIGS. 3A-B illustrate additional features of the roulette gaming table 100. At least one dealer display (e.g., displays 130a, 130b) may provide a dealer interface to enable a dealer (e.g., a croupier) to control aspects of roulette gaming events, including the first roulette wheel 110a and a second roulette wheel 110b. A first display 130a may correspond to the first roulette wheel 110a and the second display 130b may correspond to the second wheel 110b. In some examples, one or both displays may have a Radiofrequency Identification (RFID) reader to allow a dealer, supervisor, or other employee to log into the game. Under one of the dealer displays, (e.g., display 130a), a third display 130c may provide another gaming interface, such as a tournament display interface to allow the dealer to manage aspects of a Tournament game. Various interfaces, including live video feeds (e.g., PIDs), dealer interfaces, and the tournament display interface, may be interchanged between any of the displays at the roulette gaming table.

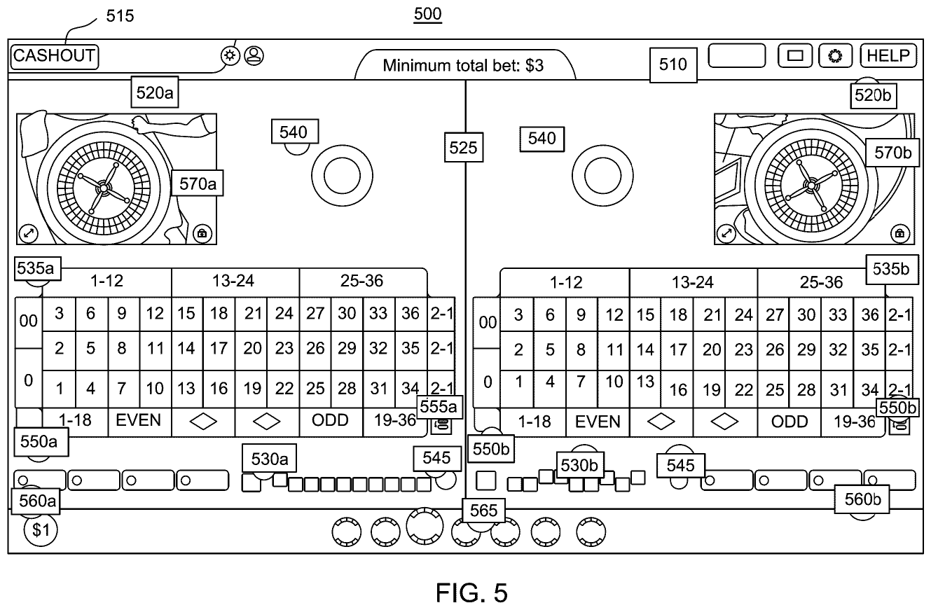

As noted above with respect to FIGS. 1A-1B, the roulette table may include at least one camera (e.g., cameras 140a, 140b) which can record a live feed of the roulette wheels. The live feed may be displayed, for example, on one or both of the dealer displays 130a, 130b, or on a display associated with a player station or player device. The live video feed may be provided as a Picture-in-Display (PID) or a Picture-in-Picture (PIP). In a PID, the live video feed may fill an entire display. In PIP, the live video feed may be provided within a portion of a display, such as on a gaming interface (see, e.g., FIG. 5) and/or overlaid on another image on the display.

The roulette wheels 110a, 110b may be standard roulette wheels. Embodiments support both single zero roulette wheels and double zero roulette wheels. Roulette wheels with alternative designs or numbering may also be applied and operated with the roulette gaming table embodiments discussed herein. One or both roulette wheels may be manual wheels, semi-automatic wheels, or automatic roulette wheels. A manual wheel may require a dealer to manually initiate a spin of the roulette wheel. A semi-automatic wheel may require at least one manual feature, such as a selection on the dealer console to initiate the spin of the roulette wheel, and a computing device or controller may manage other features, such as a spin speed, a timing of a ball launch, a determination of a result, and similar operational features. An automatic wheel may fully automate operational features of the roulette wheel.

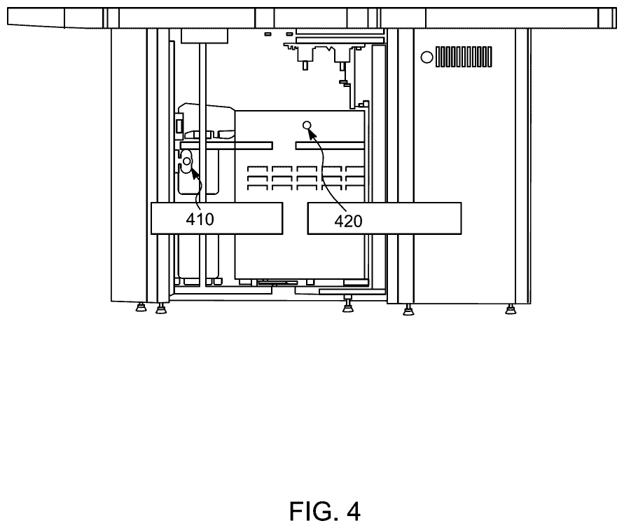

The roulette gaming table may include an interior portion, such as a hollow portion providing shelves and/or space for electronics and other items. The interior portion may be accessible via one or more doors 305 that enclose and protect components within the interior portion. As seen in FIG. 4, at least one door may include a door lock 410 to prevent unauthorized access to the interior portion. Other security features, such as an alarm, an RFID reader, or other sensors (e.g., tilt detection sensors, light sensors, etc.) may be added to protect contents within the gaming cabinet, restrict access, and reduce a risk of damage or theft of one or more components of the roulette gaming table.

The interior portion may include at least one controller for managing aspects of the gaming events, and gaming interfaces. A controller unit 310 may include one or more switches and sensor units for operating any on-table cameras (e.g., cameras 140a, 140b). In some examples the controller unit 310 may include a switch for turning one or both cameras on and off. A sensor unit may, for example, determine one or more environmental conditions (e.g., lighting) to adjust an aspect of the cameras and the video feed.

A gaming unit 320 may include at least one gaming controller to operate the roulette game. The gaming unit 320 may include software configured to at least provide and manage the dealer interface, player interface(s), a timing of roulette wheel spins and roulette ball launches, a result determination, and a wager resolution. (See, e.g., FIGS. 5-7B). The gaming unit 320 may include multiple computing devices, such as a first computing device to operate and manage gaming aspects related to the first roulette and a second computing device to operate and manage gaming aspects related to the second roulette wheel.

A PIP controller 330 may manage aspects of the one or more visual displays used with roulette gaming table. The PIP controller 330 may include software configured to arrange one or more of images and videos on a player interface and the dealer interface(s). For example, the PIP controller 330 may manage one or more aspects related to video size, position, and resolution on displays. A live video feed, for example, may be provided on a gaming interface, such as overlaid on a betting layout provided on a display on a player station. In some examples, the PIP controller may manage image and video display and placement related to one or more games, jackpots, and tournaments playable with the roulette gaming table. The PIP controller 330 may be wired or wirelessly connected to other electronics components housed within the gaming cabinet. In some examples, the PIP controller 330 is housed external to the gaming cabinet and communicates with one or more displays and player stations wirelessly.

A PID controller 350 may similarly manage aspects of the one or more visual displays used with the roulette gaming table. A PID controller 350 may provide a picture or video within a display. The PID controller may modify picture or video sizing, resolution, position, and other visual characteristics to fit on displays of various sizes. In an example, the PID controller 350 may include software to operate a Tournament game. The Tournament display may provide a unique interface for player devices, through which players may compete against each other during gaming events, such as one or more roulette gaming events. The PID controller may provide additional visual and/or interactive features to connected displays, such as alternate gaming events, advertisements, and information.

A power switch 340 may be provided within the interior portion to turn one or more electronics components on and off. In an example, a main power switch controls power to the displays, cameras, roulette wheels, controllers, and other electronics housed within the gaming cabinet. The power switch 340 may be associated with a power unit that may manage power to and from one or more components of the roulette gaming table.

The roulette gaming table of FIG. 3B may further include a control switch 160 to adjust a height of the table. Since the roulette gaming table may be used in arena/stadium environments, the table height may need to be adjusted so players at player stations can better see the physical roulette wheels. The adjustable height may also benefit the dealer, and help them better view the plurality of players and player stations.

FIG. 4 illustrates example security features associated with the roulette gaming table. A door lock 410 may lock a door providing access to the interior portion of the gaming cabinet. The front door lock, as discussed herein, may be a physical lock (e.g., requiring a key), an electronic lock (e.g., requiring a scan of an identification card, a passcode entry, or other form of electronic authorization), a magnetic lock, or any other type of device to secure the interior portion and prevent unauthorized access. Similarly, an interior lock 420 may be provided to secure one or more components within the gaming cabinet, such as a computer or controller box. Additional security features may be implemented, as needed, on or within the gaming cabinet.

FIG. 5 illustrates an example player interface 500 including dual betting layouts corresponding to the roulette wheels on the gaming table. A first betting layout may correspond to the first roulette wheel and the second betting layout may correspond to the second roulette wheel. The betting layout will correspond to available numbers and betting options provided on the respective roulette wheel. The player interface supports Single Zero roulette games and Double Zero roulette games. FIG. 5 illustrates an example interface to be used with Double Zero roulette wheels. The player interface may be provided on a display associated with a player station or other player device, such as a mobile computing device, tablet, or laptop.

A top bar 505 of the player interface may provide a summary regarding the roulette game and one or more quick-action selections. The top bar 505 may indicate credits 505, including a “Credit” box indicating a total number of credits, e.g., related to a player account, and a “Playable” box indicating an amount of credits that the player can bet. A “Cash Out” button 515 enables a player to cash out and receive any player credits via ticket printer, a credit add to a player account, or a cash pay out from a dealer. The Cash Out selection 515 may only be available when no bets are currently on the table.

Configurable selections 510 may be provided to enable a player to customize a view of the player interface. For example, an opacity button may be provided to enable a player to reduce the visibility of the player's credits, last bet(s), and the playable amount. A “Main Information” display may provide gaming information, such as when a betting window opens, a time left in the betting window, and when a betting window closes. Error messages may also be provided. A “Call Attendant” or “Concierge” button may signal an attendant of the gaming device, an attendant on the casino floor, or another individual associated with the gaming location and assisting players. A “Flag” button may indicate a language used on the interface, and a selection of the button may enable a player to change the interface language. An “Options” button may bring up a menu that includes additional information about the gameplay or the device. In some examples, the Options menu may include “Show Winnings,” which will display, as the user places bets, possible winnings for each bet. The possible winnings may be enabled or disabled using a slider or other toggle button. A “Number Orientation” option will allow a player to set a desired number orientation on the roulette table view to be vertical or horizontal. A “Show Bet Limits” option will change a display of the roulette table to a display of bet limits for different wagering options. A “Reserve Table” option allows players to reserve a player station for a period of time. A “Help/Rules” option displays a help screen.

Betting information 520a, 520b may be separately provided for each roulette wheel. The betting information may indicate a Bet, Last Win, and Last Bet information. A Display Adjustment button 525 allows a player to adjust their gaming layout left and right. One gaming layout may be enlarged while the other is decreased. A history bar 530a, 530b on each betting layout will display the last pre-set number of wins corresponding to the respective wheel.

A betting table 535a, 535b provides respective betting layouts including betting fields arranged similarly to a live table. The betting table includes the betting options and combinations. Players may choose one or more selections to assign a bet.

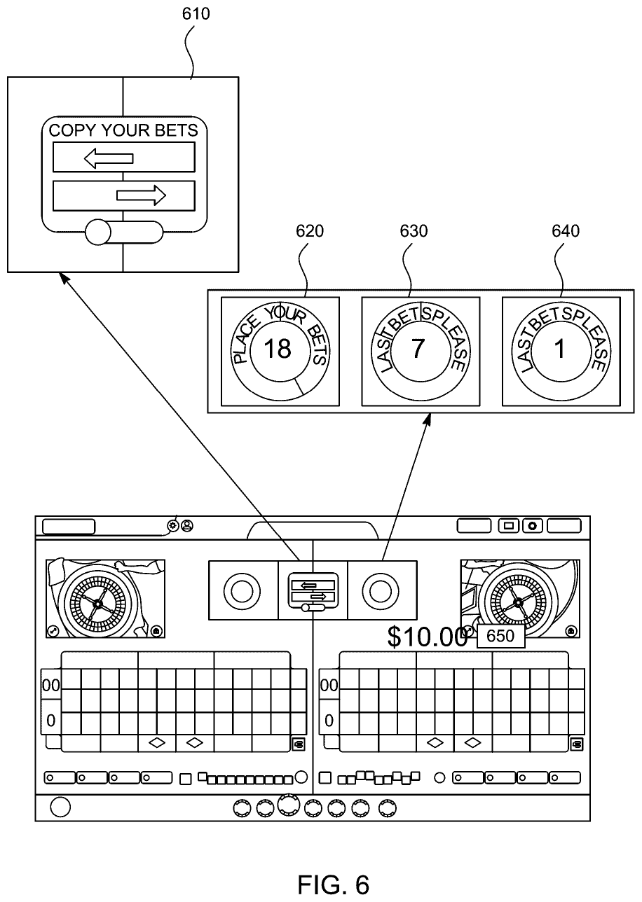

A bet timer 540 provides an indication of whether a betting window is open or closed and may provide a time left for a player to place a bet. (See also, FIG. 6). A Statistics button 545 may be provided on each betting layout to see respective gaming statistics for each roulette wheel.

A “Special Bets” button 550a, 550b may be provided on each betting layout to bring up additional betting combinations for roulette. Such betting combinations may include but are not limited to Single Zero, Double Zero, Triple Zero, Neighbors of (Big) Zero, Small Series, Orphans, Final, Complete, Red Snake, Red Splits, Black Splits, and Neighbors.

A Wheel Bet View button 555a, 555b may change the table layout to a wheel bet view, where numbers are placed in a circular order as they appear on the roulette wheel. In the wheel bet layout, players may place bets only on single numbers.

Controls 560a, 560b enable Denomination, Chips 565, and Game Controls for each respective layout. A Denomination control sets the value of one credit and hence the value of the game. The selected value of one credit may be displayed on the denomination button. The Chips control 565 enables players to select and place chips of different values on the table. Values assigned to chips may be defined with the selected denomination. In some examples, if multi-denomination is disabled, only chips may be available. The Game Control selection may include features to Clear Last Bet, Clear All Bets, Double Bet, Repeat Last Bet, Game Chips, and Fast Bet (i.e., selecting multiple options by dragging a finger across desired fields).

A PIP display 570a, 570b provides a live video feed of the roulette wheel, in real-time. The live video feed may show all aspects of the gaming event in real-time, including but not limited to, a start of the wheel spin, a roulette ball launch, and a gaming event result, such as when the roulette ball falls into a pocket. The PIP display may be enlarged or minimized using an arrow button. The PIP display may also be moved and locked to a desired position.

FIG. 6 illustrates additional betting layout features. A “Copy Bets” button 610 allows a player to copy all of their bets from one layout to the other layout. Bets may be copied manually or automatically. An arrow button, for example, may allow a player to easily copy bets from the left side to the right side or vice versa. If bets are already placed on one game, the “Copy Bets” button may only copy the highest valued bets.

Betting indicators 620, 630, 640 may provide information regarding whether a betting window is open or closed, and to help a player to quickly determine where and when to place bets. A first indicator 620 may be provided in a first color (e.g., green) to indicate that a betting window is open. The indicator 620 may also provide text (e.g., “Place Your Bets”) and a time left in the open betting window. A second indicator 630 may be provided in a second color (e.g., yellow) to indicate that a betting window is closing soon. The indicator 630 may also provide text (e.g., “Last Bets Please”) and the time left in the open betting window. A third indicator 640 may be provided in a third color (e.g., red) to indicate that betting window has minimal time left and/or that a betting window is closed. The indicator 640 may also provide text (e.g., “Last Bets Please” or “No More Bets”), any time left in the betting window, or a time until a new betting window is opened. A Win Amount (e.g., $10.00) may be displayed on the interface following a gaming event. The Win Amount may be displayed using one or more colors and animations on the display.

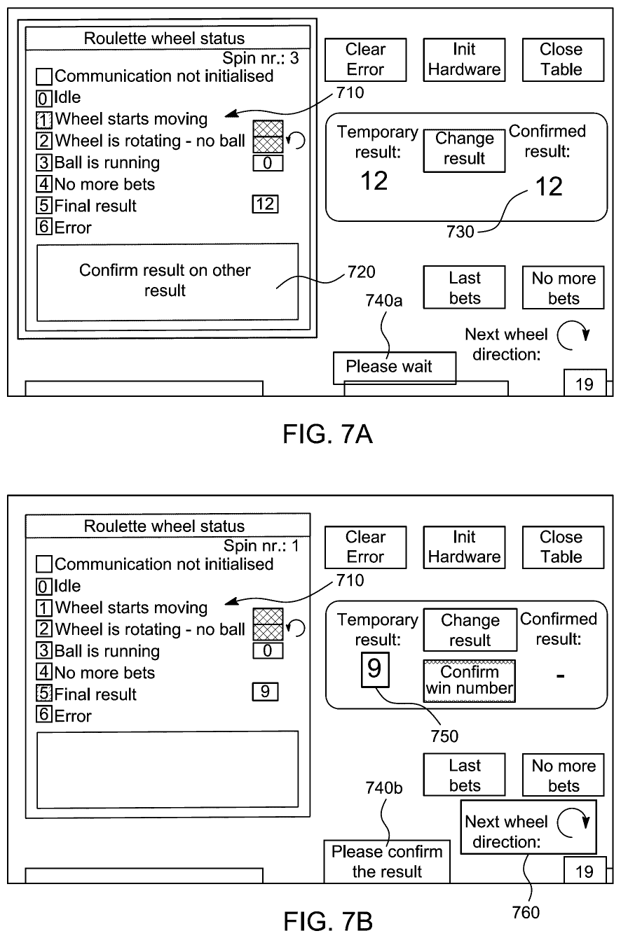

FIG. 7A and 7B illustrate dealer display interfaces. In examples, the roulette gaming table may include two dealer displays-one for each roulette wheel. Dealer displays may be connected to a separate a separate computing device, which runs an independent dealer interface. The computing devices may communicate both roulette wheel statuses with each other, for example, over an Ethernet switch. This allows each dealer interface to display a message notifying the dealer when an action needs to be performed on the other dealer interface.

FIG. 7A illustrates a first dealer interface which may be displayed during an open betting window for a first roulette wheel. FIG. 7B illustrates a second dealer interface which may be displayed after a roulette wheel spin of a second roulette wheel. The interface of FIG. 7A may be provided on a first display of a roulette gaming table, and the interface of FIG. 7B may be provided on a second display of the roulette gaming table.

Dealer interfaces may provide a “Roulette Wheel Status” area 710 providing a current status of the roulette wheel. Information may include whether communication is/is not initialized, an idle status, a wheel start status, a wheel rotation status without the ball, a presence of the roulette ball in the wheel, a betting window status (e.g., “No More Bets”), a final result, an error, and in box 720, information may be presented regarding an action to be taken (e.g., “Confirm result on other center”), and/or information regarding the other wheel or user interface. For example, a message area 740a, 740b positioned at the bottom of the dealer interface may indicate instructions and/or a next step required before a next game may proceed.

In the Results area 730, a temporary result 750 will automatically populate when a roulette ball lands in a pocket on the roulette wheel. The temporary result may be determined from one or more sensors associated with the roulette wheel, such as an optical sensor or pressure sensor within a pocket. A dealer must confirm the result prior to a next wheel spin at the other wheel. The dealer confirmation helps safeguard against errors, such as mechanical and/or detection errors, which might provide a mistaken result.

A wheel spin direction 760 may also be provided on the dealer interface. The wheel spin direction allows a dealer to set which direction the associated roulette wheel will spin. In some examples, each wheel may be set to spin in a same direction (e.g., clockwise or counterclockwise), or in opposite directions. The wheel spin direction 760 adds a level of customization and excitement to roulette gaming events.

In another example, a first wheel spin may be in any direction (e.g., clockwise or counterclockwise), and a second wheel spin may be in a direction selected by the dealer. Depending on jurisdiction, local rules, gaming conventions, or house preferences, wheel spins may be set to be in a same direction, different directions, or change according throughout continued gameplay at the roulette table.

In an example gameplay flow, a player may join a live roulette table game by logging in to a player account and/or adding credits to a player station. Credits will be displayed on the player interface. The player may bet on the wheel that currently has open bets. Only one roulette wheel will have an open betting window at a time. At the dealer interface, a dealer may select a button (e.g., “Last Bets”) to inform players that the open betting window will close soon. The dealer may select a button (e.g., “No More Bets”) to close the betting window. In some examples, the betting window closes automatically, after a given time has expired. In other examples, the betting window closes automatically when a ball is launched, such as when the dealer selects a launch command at the dealer interface.

When the ball is launched, the betting window on the other roulette wheel will open. When the roulette ball on the first roulette wheel stops spinning, the winning number is automatically recognized. The dealer confirms the winning number at the dealer interface, and the result is displayed on player stations. The dealer may then close the betting window on the second roulette wheel and/or launch the roulette ball on the second roulette wheel. The betting window then opens on the first roulette wheel. The result of the second roulette wheel will be automatically detected, then confirmed by the dealer. The betting window on the first window closes as discussed above, and the gaming cycle repeats.

FIG. 8 provides an illustration of the live ETG roulette game 800. The roulette game 800 includes two roulette wheels 810 with their own random number generators 820 underneath (or remotely located), a display 830 for displaying the results for both roulette wheels 810 a single dealer with a dealer console 840, and a plurality of player consoles 850. The display 830 is divided between the two roulette wheels 810, one side one color and one side a different color so players can readily tell them apart. Synchronization between the two roulette wheels 810 may be controlled by the dealer console 840 or automatically controller by the random number generators 820. The dual roulette wheels 810, combined with the player consoles 850 automatically settling bets in place of the dealer, results in three to four times more game results per hour with virtually zero payout errors. The fact that one dealer can deal more live roulette to any number of players greatly increases revenue, while the increase in player to dealer ratio, eliminating 1-2 full-time equivalent (FTE) employees, and reducing the compensation cost associated with only needing less skilled dealers, greatly enhances profitability.

FIG. 9 illustrates an example arrangement of the ETG roulette game within an stadium environment, which may include a live arena, or casino pit. In various examples, up to 240 stations can be connected to the roulette game. In some examples, as illustrated in FIG. 9, the player stations may be arranged around the roulette gaming table in an arena or stadium on a casino floor. In various embodiments, the one or more player stations are arranged in one or more rows 910, 920 extending outwardly from the roulette gaming table. Player stations may be grouped together (e.g., two, three, or more) to allow groups of players to play near each other. Individual player stations may also be provided for solo play within the stadium environment. The one or more player stations may be positioned to face the roulette gaming table, so as to allow viewing of a display, the dealer, and/or the physical roulette wheels at the roulette gaming table. The roulette gaming table may be on a raised platform, or otherwise have its height position adjusted to accommodate the particular characteristics of the room. Some stadium arrangements, for example, may include a pit area. The pit area may slope downwards towards the roulette gaming table, such that the one or more player stations are at a higher height than the roulette gaming table and can better view the physical roulette wheels.

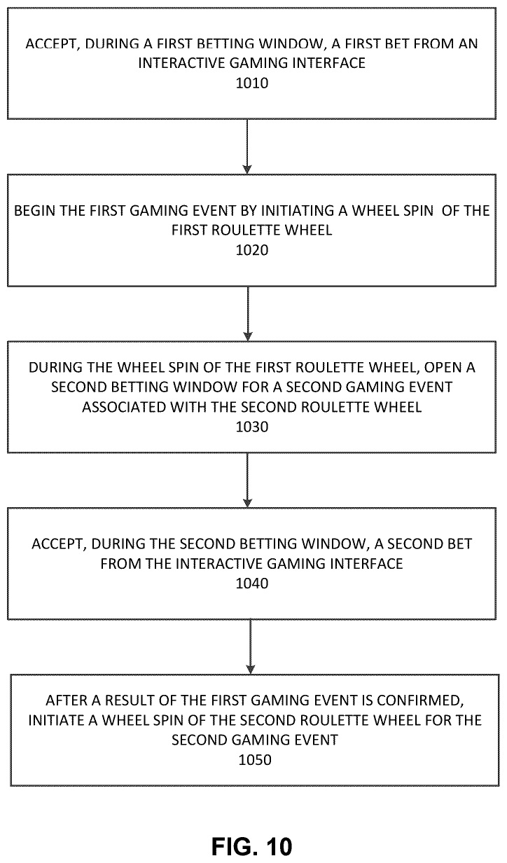

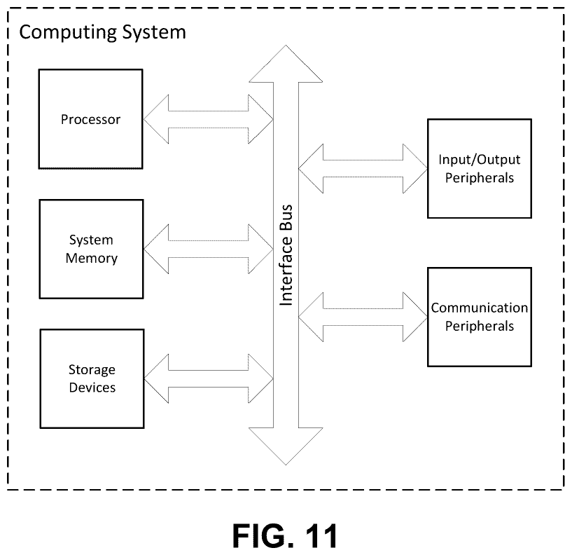

FIG. 10 illustrates a flow chart with gameplay operations of a live roulette gaming table and player stations. At block 1010, aspects may accept, during a first betting window, a first bet from an interactive gaming interface. A length of the first betting window may be defined via the dealer console, e.g., through an interactive user interface. One or more notifications may be provided to the player interface regarding a length of time left in the first betting window.

At block 1020, aspects may begin the first gaming event by initiating a wheel spin of the first roulette wheel. The first gaming event may be initiated through the dealer console. A selection may initiate at least one of a wheel spin and a ball launch.

At block 1030, aspects may, during the wheel spin of the first roulette wheel, open a second betting window for a second gaming event associated with the second roulette wheel. The second betting window may open when the roulette event (e.g., a wheel spin, a ball launch, etc.) at the first wheel has started. The first betting window and the second betting window will not be available at a same time.

At block 1040, aspects may accept, during the second betting window, a second bet from the interactive gaming interface. Similar to the first betting window, bets may be received from one or more player stations playing with the dual roulette station.

At block 1050, after a result of the first gaming event is confirmed, initiate a wheel spin of the second roulette wheel for the second gaming event. The alternating betting and gaming cycle between the dual roulette wheels may continue.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The techniques described above can be implemented on a computing device associated with a gaming device (e.g., a roulette machine operating a live roulette game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 9 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a live roulette gaming system, comprising: a roulette gaming table comprising a first roulette wheel and a second roulette wheel; and at least one computing device comprising a processor and a memory, the memory comprising instructions, which when executed by the processor, causes the at least one computing device to: accept, during a first betting window, a first bet from an interactive gaming interface, wherein the bet is for a first gaming event to be played on a first roulette wheel at the roulette gaming table; at a dealer console at the roulette gaming table, begin the first gaming event by initiating a wheel spin of the first roulette wheel; during the wheel spin of the first roulette wheel, open a second betting window for a second gaming event associated with the second roulette wheel at the roulette table; accept, during the second betting window, a second bet from the interactive gaming interface; close the second betting window when the wheel spin of the first roulette wheel ends; and after a result of the first gaming event is confirmed at the dealer console, initiate a wheel spin of the second roulette wheel to begin the second gaming event.

In an embodiment, the live roulette gaming system of claim 1, further comprising: one or more player stations arranged around the roulette gaming table, wherein each of the player stations comprise a display providing the interactive gaming interface.

In an embodiment, wherein the one or more player stations are located in an arena on a casino floor, wherein the arena comprises an interior area and a perimeter, and the one or more player stations face the roulette gaming table.

In an embodiment, wherein the interactive gaming interface display comprises a first area comprising a betting layout associated with the first roulette wheel, and a second area comprising a betting layout associated with the second roulette wheel.

In an embodiment, wherein the first area further comprises a live video feed of the first roulette wheel, and the second area further comprises a live video feed of the second roulette wheel.

In an embodiment, wherein the interactive gaming interface displays at least one of: a time left in the second betting window and a result of the first gaming event.

In an embodiment, wherein the at least one computing device is further configured to: automatically resolve the bet for the first gaming event after the result of the first gaming event is confirmed.

In an embodiment, a method for operating a dual roulette table, comprising: accepting, during a first betting window, a first bet from at least one player interface, wherein the bet is for a first gaming event to be played on a first roulette wheel at the dual roulette table; at a dealer console at the dual roulette table, beginning the first gaming event by initiating a wheel spin of the first roulette wheel; during the wheel spin of the first roulette wheel, opening a second betting window for a second gaming event associated with the second roulette wheel at the dual roulette table; accepting, during the second betting window, a second bet from the at least one player interface; closing the second betting window when the wheel spin of the first roulette wheel ends; and after a result of the first gaming event is confirmed at the dealer console, initiating a wheel spin of the second roulette wheel to begin the second gaming event.

In an embodiment, wherein the dealer console comprises an interactive dealer interface providing a selection to manage one or more operational aspects of the dual roulette table.

In an embodiment, wherein the selection is indicative of at least one of: a time left to accept bets, a bet cutoff, a gaming result confirmation, a table closure, and a roulette ball launch.

In an embodiment, further comprising: providing a live video feed of the first roulette wheel and the second roulette wheel on the at least one player interface.

In an embodiment, further comprising: confirming, via a selection at the dealer console, the result of the first gaming event.

In an embodiment, further comprising: during the wheel spin of the second roulette wheel, opening a third betting window for a third gaming event associated with the first roulette wheel at the dual roulette table.

In an embodiment, wherein the at least one player interface is associated with one or more player stations positioned within a same location as the roulette gaming table.

In an embodiment, wherein the one or more player stations are positioned to enable a player to view the first roulette wheel and the second roulette wheel.

In an embodiment, wherein the one or more player stations are arranged in a stadium configuration, wherein the stadium configuration comprises a plurality of rows extending outwardly from the roulette gaming table, and wherein the one or more player stations face the roulette gaming table.

In an embodiment, further comprising: setting, at the dealer console, a spin direction of the first roulette wheel prior to beginning the first gaming event, and setting, at the dealer console, a spin direction of the second roulette wheel before beginning the second gaming event.

In an embodiment, a non-transitory computer-readable medium comprising instructions stored thereon that cause a computing device to at least: accept, during a first betting window, a first bet from an interactive gaming interface, wherein the bet is for a first gaming event to be played on a first roulette wheel at a dual roulette table; at a dealer console at the dual roulette table, begin the first gaming event by initiating a wheel spin of the first roulette wheel; during the wheel spin of the first roulette wheel, open a second betting window for a second gaming event associated with a second roulette wheel at the dual roulette table; accept, during the second betting window, a second bet from the interactive gaming interface; close the second betting window when the wheel spin of the first roulette wheel ends; and after a result of the first gaming event is confirmed at the dealer console, initiate a wheel spin of the second roulette wheel to begin the second gaming event.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A live roulette gaming system, comprising:
a roulette gaming table comprising a first roulette wheel and a second roulette wheel; and
at least one computing device comprising a processor and a memory, the memory comprising instructions, which when executed by the processor, causes the at least one computing device to:
accept, during a first betting window, a first bet from an interactive gaming interface, wherein the bet is for a first gaming event to be played on a first roulette wheel at the roulette gaming table;
at a dealer console at the roulette gaming table, begin the first gaming event by initiating a wheel spin of the first roulette wheel;
during the wheel spin of the first roulette wheel, open a second betting window for a second gaming event associated with the second roulette wheel at the roulette table;
accept, during the second betting window, a second bet from the interactive gaming interface;
close the second betting window when the wheel spin of the first roulette wheel ends; and
after a result of the first gaming event is confirmed at the dealer console, initiate a wheel spin of the second roulette wheel to begin the second gaming event.

2. The live roulette gaming system of claim 1, further comprising:
one or more player stations arranged around the roulette gaming table, wherein each of the player stations comprise a display providing the interactive gaming interface.

3. The live roulette gaming system of claim 2, wherein the one or more player stations are located in an arena on a casino floor, wherein the arena comprises an interior area and a perimeter, and the one or more player stations face the roulette gaming table.

4. The live roulette gaming system of claim 1, wherein the interactive gaming interface display comprises a first area comprising a betting layout associated with the first roulette wheel, and a second area comprising a betting layout associated with the second roulette wheel.

5. The live roulette gaming system of claim 4, wherein the first area further comprises a live video feed of the first roulette wheel, and the second area further comprises a live video feed of the second roulette wheel.

6. The live roulette gaming system of claim 4, wherein the interactive gaming interface displays at least one of: a time left in the second betting window and a result of the first gaming event.

7. The live roulette gaming system of claim 1, wherein the at least one computing device is further configured to: automatically resolve the bet for the first gaming event after the result of the first gaming event is confirmed.

8. A method for operating a dual roulette table, comprising:
accepting, during a first betting window, a first bet from at least one player interface, wherein the bet is for a first gaming event to be played on a first roulette wheel at the dual roulette table;
at a dealer console at the dual roulette table, beginning the first gaming event by initiating a wheel spin of the first roulette wheel;
during the wheel spin of the first roulette wheel, opening a second betting window for a second gaming event associated with the second roulette wheel at the dual roulette table;
accepting, during the second betting window, a second bet from the at least one player interface;
closing the second betting window when the wheel spin of the first roulette wheel ends; and
after a result of the first gaming event is confirmed at the dealer console, initiating a wheel spin of the second roulette wheel to begin the second gaming event.

9. The method of claim 8, wherein the dealer console comprises an interactive dealer interface providing a selection to manage one or more operational aspects of the dual roulette table.

10. The method of claim 9, wherein the selection is indicative of at least one of: a time left to accept bets, a bet cutoff, a gaming result confirmation, a table closure, and a roulette ball launch.

11. The method of claim 8, further comprising: providing a live video feed of the first roulette wheel and the second roulette wheel on the at least one player interface.

12. The method of claim 8, further comprising: confirming, via a selection at the dealer console, the result of the first gaming event.

13. The method of claim 8, further comprising: during the wheel spin of the second roulette wheel, opening a third betting window for a third gaming event associated with the first roulette wheel at the dual roulette table.

14. The method of claim 8, wherein the at least one player interface is associated with one or more player stations positioned within a same location as the roulette gaming table.

15. The method of claim 14, wherein the one or more player stations are positioned to enable a player to view the first roulette wheel and the second roulette wheel.

16. The method of claim 14, wherein the one or more player stations are arranged in a stadium configuration, wherein the stadium configuration comprises a plurality of rows extending outwardly from the roulette gaming table, and wherein the one or more player stations face the roulette gaming table.

17. The method of claim 8, further comprising: setting, at the dealer console, a spin direction of the first roulette wheel prior to beginning the first gaming event, and setting, at the dealer console, a spin direction of the second roulette wheel before beginning the second gaming event.

18. A non-transitory computer-readable medium comprising instructions stored thereon that cause a computing device to at least
accept, during a first betting window, a first bet from an interactive gaming interface, wherein the bet is for a first gaming event to be played on a first roulette wheel at a dual roulette table;
at a dealer console at the dual roulette table, begin the first gaming event by initiating a wheel spin of the first roulette wheel;
during the wheel spin of the first roulette wheel, open a second betting window for a second gaming event associated with a second roulette wheel at the dual roulette table;
accept, during the second betting window, a second bet from the interactive gaming interface;
close the second betting window when the wheel spin of the first roulette wheel ends; and
after a result of the first gaming event is confirmed at the dealer console, initiate a wheel spin of the second roulette wheel to begin the second gaming event.
